(19) United States
(12) Patent Application Publication
(10) Pub. No.: US 2021/0300742 A1
(43) Pub. Date: Sep. 30, 2021

(54) DEVICE AND METHOD FOR REMOTELY CONTROLLING AN INDUSTRIAL TRUCK

(71) Applicant: Jungheinrich Aktiengesellschaft, Hamburg (DE)

(72) Inventors: Hannes Bistry, Pinneberg (DE); Maximilian Richter, Hamburg (DE); Lukas Riedel, Hamburg (DE); Andreas Knie, Hamburg (DE); Ralf Wetegrove, Norderstedt (DE)

(21) Appl. No.: 17/213,493

(22) Filed: Mar. 26, 2021

(30) Foreign Application Priority Data
Mar. 27, 2020 (DE) 10 2020 108 592.3

(51) Int. Cl. B66F 9/075; G05D 1/00

(52) U.S. Cl. CPC B66F 9/07581; B66F 9/0759; G05D 2201/0216; G05D 1/0022; G05D 1/0016

(57) ABSTRACT

A device for remotely controlling at least one industrial truck comprises a remote operating station comprising one or more operating elements that correspond to an operating station of the at least one industrial truck. The one or more operating elements are configured to be actuated. A control unit is configured to generate control signals in response to the actuation of the one or more operating elements. The control unit is further configured to transmit the control signals to the at least one industrial truck via a radio transmission path.

### CROSS REFERENCE TO RELATED INVENTION

This application is based upon and claims priority to, under relevant sections of 35 U.S.C. § 119, German Patent Application No. 10 2020 108 592.3, filed Mar. 27, 2020, the entire contents of which are hereby incorporated by reference.

### TECHNICAL FIELD

The invention relates to a device and method for remotely controlling at least one industrial truck. The invention also relates to a system consisting of a device of this kind and one more industrial trucks that are to be remotely controlled or that are remotely controlled by means of the device.

### BACKGROUND

Nowadays, industrial trucks are used as automatic guided vehicles (AGV) within a driverless transport system (DTS) in a large number of fields of application. The AGVs can for example perform certain tasks in a warehouse in an automated manner in accordance with their programming. For example, an AGV of this kind can pick up goods from high-bay racking and take them to a destination. A constant challenge in automatic systems of this kind are changing environmental conditions, for example obstacles entering the travel path of the industrial truck. An AGV of this kind can therefore reliably perform relatively simple tasks, such as transportation over a long, in particular straight, route. However, in the case of more complicated tasks, disruptions can occur in the automatic operation of the system and manual intervention in the control of the relevant AGV may become necessary.

In the case of such a disruption, an operator may for example manually control the AGV via an operating station thereof. Handheld controllers are also known, which can be connected to the vehicle if necessary and allow operation of the industrial truck, not only in the event of a fault, but also, for example, for maintenance or servicing purposes. Handheld controllers of this kind are common in particular if the AGVs do not have their own separate operating station or if they are so-called “man-up trucks”, the operating station of which may not be accessible in the event of a fault because it is in an extended state.

### BRIEF SUMMARY OF THE INVENTION

The object of the invention is to make remote control of an industrial truck as simple and intuitive as possible.

The device according to the invention for remotely controlling at least one industrial truck comprises a remote operating station and a control unit, wherein the remote operating station comprises operating elements corresponding to an operating station of an industrial truck, wherein the control unit is configured to generate control signals for the industrial truck to be remotely controlled in response to actuation of the operating elements of the remote operating station and to transmit the control signals via a radio transmission path to the industrial truck to be remotely controlled.

The method according to the invention provides for the remote control of at least one industrial truck by means of a remote operating station, wherein the remote operating station comprises operating elements corresponding to an operating station of an industrial truck, wherein a control unit generates control signals for the industrial truck to be remotely controlled in response to actuation of the operating elements of the remote operating station and transmits the control signals via a radio transmission path to the industrial truck to be remotely controlled.

The device according to the invention and embodiments thereof are explained in the following together with the method according to the invention. Statements made in relation to the device apply accordingly to the method and vice versa.

According to the invention, the industrial truck to be remotely controlled is remotely controlled via a remote operating station, which comprises operating elements corresponding to an operating station of an industrial truck. In other words, the operating elements of the remote operating station imitate or are identical to the operating elements of the operating station of an industrial truck in terms of function and, in particular, in terms of design. In particular, they may be the very components or assemblies that are themselves used for the operating elements of the operating station of the industrial truck. In particular, the remote operating station may partially or completely correspond to the operating station of an industrial truck. The industrial truck, the operating station of which corresponds to the operating elements or remote operating station, may in particular be the or one of the industrial trucks to be remotely controlled. The industrial truck may be manually controllable via the operating station to which the operating elements or remote operating station correspond.

For example, at least some of the operating elements of the remote operating station may be arranged on an operating head that corresponds to the operating head of an industrial truck. In particular, the remote operating station may also comprise a tiller bearing the operating head, which tiller corresponds to a tiller of an industrial truck in terms of function and, in particular, in terms of design. The operating head may also correspond to a multi-functional steering wheel of an industrial truck, as will be explained later. The remote operating station according to the invention can be operated in a particularly intuitive and simple manner on account of the operating elements corresponding to the operating station of an industrial truck. As such, an operator experienced in the operation of industrial tricks does not have to adjust to different operating elements, as a result of which incorrect operation can be avoided. In particular, the operator does not have to be trained in order to operate the remote operating station.

The control unit may be part of the remote operating station, but it may also be part of a central control system, for example the control system of a DTS comprising a plurality of AGVs. The remote operating station may communicate with the central control system in a wired or wireless manner. The control unit itself communicates wirelessly with the industrial truck to be remotely controlled via the radio transmission path. A transmission unit may be provided for this purpose. However, a transceiver unit may also be provided as part of the remote operating station or of the central control system, wherein the control unit can be, in this case, in particular also configured to receive data relevant to the remote control from the industrial truck to be remotely controlled. The control signals generated by the control unit may in particular be target values for control functions of the industrial truck to be remotely controlled. Control functions may in turn in particular be driving functions of the industrial truck to be remotely controlled, for example steering angle and/or travel speed, but also work functions of the industrial truck to be remotely controlled, for example lifting, and/or moving the mast forward. In principle, however, the control signals may also merely represent actuation of the relevant operating element of the remote operating station, wherein target values for the control functions are in this case only generated at the industrial truck to be remotely controlled that receives the control signals. Therefore, according to one embodiment, the industrial truck to be remotely controlled receives the control signals and generates target values for the control functions of the industrial truck from the received control signals, for example by means of an on-board control unit. The radio transmission path is established prior to control signals being transmitted and can be secured, for example, by means of an encryption. The radio transmission path may allow for flow control, i.e. the receiver-side check as to whether the data arrive regularly. The remote operating station, the central control unit or the on-board control unit of the industrial truck to be remotely controlled may be configured to carry out authorization and/or authentication. Within the context of authorization, it may for example be checked whether the operator of the remote operating station is authorized to remotely control the industrial truck. Within the context of authentication, it may for example be checked whether the operator using the remote operating station is who they claim to be. Various devices and methods known from the prior art are used for this purpose.

A system may be provided that comprises a device of this kind for remotely controlling an industrial truck as well as at least one industrial truck, preferably a plurality of industrial trucks, remotely controlled by means of the device. A system of this kind may in particular be a DTS, wherein the industrial trucks that otherwise drive automatically as AGVs can be remotely controlled via the remote operating station. Should a disruption occur for one of said AGVs, as explained at the outset, an operator can remotely control the relevant industrial truck in a simple manner by means of the remote operating station and thus eliminate the disruption. If a disruption occurs, for example because an obstacle enters the travel path of the AGV, the operator can steer the AGV around the obstacle by means of the remote operating station. It is also possible, during remotely controlled operation, to pick up the obstacle, for example a pallet, and take it to another location, i.e. eliminate the cause of the disruption. After the disruption has been eliminated, automatic operation of the AGV can be resumed. As already mentioned, the operating elements of the remote operating station that correspond to the operating station of the industrial truck allow for simple and intuitive operation thereof. It may not only be the operating elements or some operating elements that correspond to the operating station of an industrial truck, but, as also mentioned, an operating head or even a tiller as well. In particular, the remote operating station may comprise a complete operating station of an industrial truck, comprising the operating elements and, for example, also a standing platform.

According to a particularly preferred embodiment, the remote operating station is part of a driving simulator for industrial trucks. In particular, in this case, the remote operating station may completely correspond to the operating station of an industrial truck, in particular with original operating elements. Simulators of this kind are used to train operators in controlling industrial trucks. For this purpose, a driving simulator of this kind may for example comprise a visualization apparatus, e.g. virtual reality glasses, a screen or a head-up display, which displays simulated surroundings to the operator. The device according to the invention may also comprise a visualization apparatus of this kind independently of the present embodiment. The visualization apparatus may for example display environmental data, but also actual values of operating data, of the industrial truck to be remotely controlled, for example via a video feed. As a result, an operator can also use the remote operating station to remotely control industrial trucks that are far away and, in particular, not within the field of vision of the operator. By integrating the remote operating station according to the invention, in particular the entire device according to the invention, in the driving simulator, only a single device is required for both purposes, i.e. for remotely controlling an industrial truck and for driving simulation. This is economically advantageous. As such, a driving simulator that is possibly already present may for example be used as the remote operating station according to the invention.

According to another embodiment, the remote operating station is an operating station of an industrial truck itself. Therefore, according to this embodiment, the operating station of an actually existing, in particular functional, industrial truck is used in order to remotely control another industrial truck. The operating station may be supplemented by a visualization apparatus, as described above. The industrial truck may be manually controllable via its own operating station. The system explained above may accordingly comprise an industrial truck having the remote operating station as its own operating station. Therefore, an industrial truck that is in particular already present can be used to remotely control another industrial truck. In this case, it is not necessary to provide a separate remote operating station merely intended for remote control. Rather, the operating station of a possibly already present industrial truck can be used as the remote operating station for another industrial truck. If a disruption occurs in the DTS explained above, an operator can use the operating station of their own manually operable industrial truck as the remote operating station for the AGV experiencing the disruption and connect to said AGV. This is possible in particular in current generations of industrial trucks, since these are typically configured according to the “drive-by-wire” principle, i.e. there is no mechanical connection between the operating elements and the vehicle mechanics, but only an electrical one. The control signals generated via the operating elements of the operator's industrial truck can therefore be transmitted in a remote mode to the industrial truck to be remotely controlled instead of to the operator's industrial truck. A transmission unit or transceiver unit already present on the industrial truck may be used for this purpose. The control unit of the industrial truck carrying out the remote control can also generate a target value for the remotely controlled industrial truck. In principle, however, this can also take place via a central control system or at the industrial truck receiving the control signals, as already explained.

According to an embodiment, the industrial truck comprising the remote operating station is configured to be remotely controllable by means of an accordingly configured, additional remote operating station. Said additional remote operating station may in particular also be an operating station which belongs to another industrial truck and via which said industrial truck can otherwise be manually controlled. As a result, the industrial truck comprising the remote operating station may be an industrial truck that is configured for manual as well as automatic operation. Said industrial truck can in turn be remotely controlled, in particular during automatic operation. The above-mentioned system may comprise a plurality of industrial trucks that can remotely control one another. In particular, all industrial trucks of the system may remotely control one another in the manner according to the invention. As such, in the event of a disruption in the above-explained DTS, the AGV experiencing the disruption can for example be remotely controlled by means of another AGV of the DTS. This therefore produces a closed DTS by means of which potentially occurring disruptions in automatic operation can be resolved in a simple manner by means of manual intervention. This may be expedient, for example, if the AGV affected by the disruption is very far away or is difficult to reach, or if it does not have its own operating station. In particular, in this case, no separate remote operating station or additional industrial truck that is independent of the system is required.

According to one embodiment, the remote operating station comprises an operating head corresponding to the operating station of an industrial truck, wherein at least some of the operating elements are arranged on the operating head. In particular, the entire operating head including all operating elements relevant for remote control may correspond to the operating station of an industrial truck, in particular an industrial truck to be remotely controlled. As mentioned, they may in particular be the same components. The operating head may for example comprise a horn that extends along the longitudinal axis of the operating head, support portions extending from the longitudinal axis on opposite sides of the horn and handles that are connected to the horn and that comprise gripping portions arranged in each case opposite the support portions. The opposing support portions and gripping portions can in each case be spaced apart from one another by means of a handle opening. The operating elements may in particular be arranged on one or both support portions. There may also be a driver gearshift handle as an operating element, in particular on one end of the horn. This makes operation of the remote operating station all the more intuitive.

According to an embodiment, the remote operating station comprises a tiller having a tiller shaft, on the free end of which the operating head is arranged. The tiller may in particular be pivotable about a horizontal axis. Furthermore, the tiller of the remote operating station corresponds to the tiller of an industrial truck and therefore in particular also allows for intuitive remote control of tiller-guided industrial trucks. The tiller thereby also operates in particular as per the above-mentioned “drive-by-wire” principle, i.e. merely generates electrical signals without mechanically engaging in a vehicle mechanical system.

According to another embodiment, the operating head is a multi-functional steering wheel, and therefore the remote operating stations comprises an operating head corresponding to the multi-functional steering wheel of an industrial truck.

According to another embodiment, the remote operating station has the shape and operating element of a steering wheel for passenger industrial trucks according to EP 1 155 939 B1.

According to another embodiment of the invention, the remote operating station has the shape and operating elements of an industrial truck according to EP 1 772 344 B1 or EP 1 030 816 B1.

According to one embodiment, the operating elements include one or more of the following: travel switches; rocker switches; switch buttons; levers for the travel drive; stop buttons; locking rockers for a permanent creep speed; buttons for sounding the horn; buttons for raising and lowering a load-carrying means of the industrial truck; and buttons for selecting forward or reverse travel. In an embodiment, the above-mentioned operating elements are modeled on the operating elements of an industrial truck and may therefore have the same design and function, in particular. They may be original components, i.e. the same components that were also used for the on-board operating station of the industrial truck. The operating elements may be arranged on the above-mentioned operating head.

According to an embodiment, the radio transmission path is secured and/or has flow control. The control unit is configured to transmit control signals at least every 50 ms, preferably at least every 40 ms, particularly preferably at least every 30 ms in order to secure the radio transmission. This can help to ensure that the radio transmission path is secured, since an almost constant data flow is ensured. As a result, even in the event of a brief interruption to the connection to the industrial truck to be remote-controlled, the control signals can still reach the industrial truck to be remotely controlled with relatively high reliability. Such control signals may—as long as the radio transmission path exists—also be sent out in an almost constant data flow if an operating element of the control unit is in its neutral position, i.e. not actuated. According to one embodiment, the control unit is configured to secure the radio transmission path by means of error detection. For example, a cyclic redundancy check (CRC) may take place as the error detection. As a result, the control unit can attach a CRC value to each of the control signals for the purpose of redundancy. Flow control may also take place, i.e. the receiver-side check as to whether the data arrive regularly. As a result, the radio transmission path can be secured in particular against interference signals.

According to one embodiment, the control unit is configured to secure the radio transmission path by means of encryption. This can take place using any known encryption methods. As a result, the radio transmission path can be secured in particular against unauthorized access.

According to one embodiment, the control unit is configured to receive vehicle data and/or environmental data relevant for the remote control from the industrial truck to be remotely controlled and to take said data into consideration when generating the control signals. The industrial truck to be remotely controlled may, in this regard, comprise different sensors, for example proximity sensors and/or cameras for recording environmental data. The vehicle data may come from a vehicle control system belonging to the industrial truck and for example include a current speed, a steering angle and/or a lift height of a potentially provided mast. According to this embodiment, the control unit therefore receives feedback from the industrial truck to be remotely controlled. Data from (safety) laser scanners potentially provided on the AGV may for example be used to define a maximum speed in remote-control mode. The vehicle data and in particular the environmental data can additionally be displayed to an operator using the remote operating station via a visualization apparatus, for example via a screen, a head-up display or virtual reality glasses, as already mentioned.

According to an embodiment of the system, the at least one remotely controlled industrial truck comprises no on-board operating station. It may in particular only be possible to control an industrial truck of this kind remotely, for example via the remote operating station. The industrial truck may otherwise operate as an AGV within a DTS, for which no on-board operating station is required. In particular, it can be provided that the at least one remotely controlled industrial truck comprises no on-board operating elements whatsoever. Simple and intuitive operation of an industrial truck of this kind is possible by virtue of the remote operating station provided according to the invention. Dispensing with an on-board operating station or some operating elements reduces the weight and costs.

The system, the device and the method for remotely controlling at least one industrial truck may also be used during normal operation in the warehouse, in which an operator monitors and controls at least one industrial truck from afar.

### BRIEF DESCRIPTION OF THE DRAWINGS

Embodiments of the invention are explained below using figures. In the drawings:

FIG. 1 illustrates a schematic view of an embodiment of a device for remotely controlling an industrial truck where the remote operating station is part of a driving simulator;

FIG. 2 illustrates a schematic view of an embodiment of the device for remotely controlling an industrial truck, wherein the operating station of an industrial truck serves as the remote operating station; and

FIG. 3 illustrates a perspective view of an embodiment of an operating head of the remote operating station that is modeled on an operating station of an industrial truck.

If not otherwise specified, the same reference numbers indicate the same objects below.

### DETAILED DESCRIPTION OF THE INVENTION

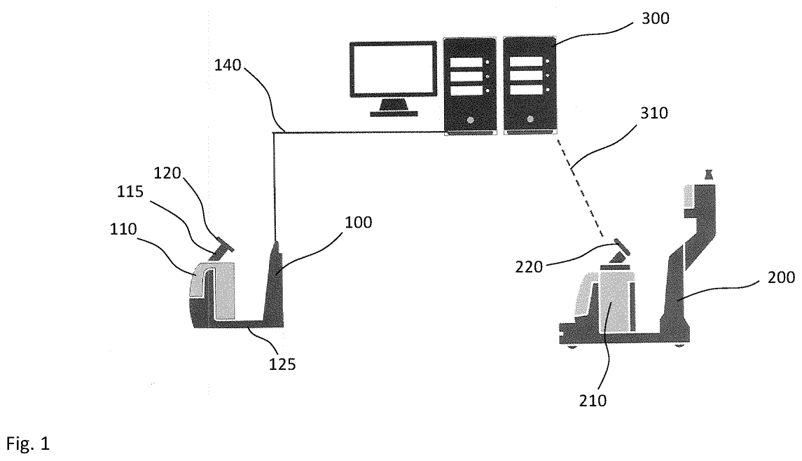

FIG. 1 shows a first embodiment of the invention. The device according to the invention comprises a driving simulator 100 having an operating station 110 and a control unit 300. The operating station 110 of the driving simulator 100 comprises an operating head 120 arranged on a free end of a tiller 115. The driving simulator 100 is connected to the control unit 300 via a data line 140. The cable connection 140 may also be replaced with a cableless connection. The control unit 300 is in the present case configured as a central control system and is represented schematically by means of two computers and a screen.

The operating station 110 of the driving simulator 100 is configured as a remote operating station according to the invention and is denoted by the reference sign 110 in the following. The remote operating station 100 as well as the tiller 115 and the operating head 120 including all operating elements (not shown) arranged thereon are each modeled on the corresponding components of an industrial truck. They may be original components of an operating station. In particular, the entire remote operating station 110, for example also comprising a standing platform 125, may correspond to the operating station of an industrial truck. The driving simulator 100 is used, in principle, to train employees to operate industrial trucks. However, the driving simulator 100 may, according to this embodiment, also be used to remotely control an industrial truck 200.

The industrial truck 200 may in particular be an automatic guided vehicle (AGV) as part of a driverless transport system (DTS), and may therefore operate automatically in regular operation. In the event of a disruption, for example if an obstacle enters the travel path, the AGV 200 can be remotely controlled using the method according to the invention. An operator can use the remote operating station 110 of the driving simulator 100 for this purpose. By actuating the operating elements (not shown in FIG. 1) of the remote operating station 110, signals are transmitted via the cable connection 140 to the control unit 300, which generates control signals for the industrial truck 200 to be remotely controlled in response to these signals and transmits said control signals to the industrial truck 200 via a secured radio transmission path 310. The control unit 300 may, in principle, also be part of the driving simulator 100. The control signals in particular comprise target values for control functions of the AGV 200, in particular target values for driving functions of the AGV 200, for example steering angle and/or travel speed, or target values for work functions of the AGV 200, for example lifting, and/or moving the mast forward.

Since the remote operating station 110 according to the invention with its operating elements and in particular the operating head 120 corresponds to the operating station of an industrial truck, the remote control of the industrial truck 200 is particularly simple and intuitive using the remote operating station 110 according to the invention. The remote operating station 110 according to the invention may in particular correspond to an operating station 210 of the industrial truck 200 to be remotely controlled, wherein the operating head 120 in particular corresponds to an operating head 220 of the industrial truck 200. This makes remote control of the industrial truck 200 particularly intuitive. Moreover, this embodiment allows for the use of a potentially already present driving simulator for remotely controlling industrial trucks.

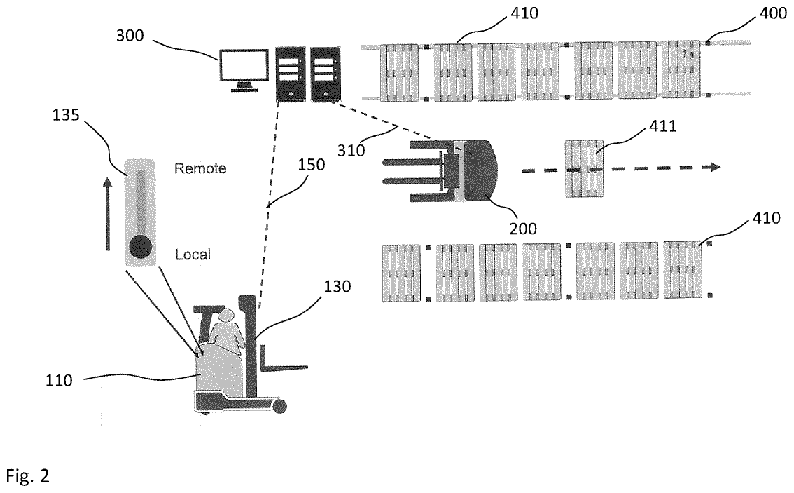

A second embodiment of the invention can be seen in FIG. 2, wherein the remote operating station 110 is in this case implemented by the operating station of an industrial truck 130. The industrial truck 130 is in principle ready to operate and is manually controlled by an operator via the operating station of the industrial truck 130 during regular operation. In said regular operation, i.e. in the case of manual, local control of the industrial truck 130 itself, the operating station 110 is set to “local” via a switching element 135, as shown in FIG. 2. FIG. 2 again shows the control unit 300 as well as the industrial truck 200 to be remotely controlled. The industrial truck 200 to be remotely controlled, also an AGV in this case, is shown in a plan view in a shelving aisle, wherein shelves 400 with pallets 410 are arranged on both sides of the industrial truck 200. During regular operation of the DTS comprising the AGV 200, the AGV 200 automatically transports the pallets 410 between the shelves 400 and another location.

If a disruption occurs in the DTS, for example because there is a pallet 411 in the travel path of the AGV 200, the automatic control system of the AGV 200 may potentially be overwhelmed, because this is a non-implemented situation. In this case, manual intervention may be necessary. For this purpose, according to the invention, the operator of the industrial truck 130 can put the operating station 110 of their industrial truck into the remote state using the switch 135, in which remote state the operating station 110 serves as a remote operating station for remotely controlling the AGV 200. Control commands given by the operating elements (not shown) of the operating station 110 are transmitted via a radio connection 150 to the central control unit 300, which translates said control commands into target values for the AGV 200 to be remotely controlled and transmits same to the AGV 200 via the radio link. As such, the industrial truck 200 can be remotely controlled in a simple manner by means of an industrial truck 130 that is already present. Furthermore, the radio connection 150 between the industrial truck 130 and the control unit 300 is preferably secured, for example encrypted.

In both embodiments, the target values for the control functions of the industrial truck 200 to be remotely controlled can also be generated at the remote operating station 110 or at the industrial truck 200 to be remotely controlled itself, instead of at the central control unit 300.

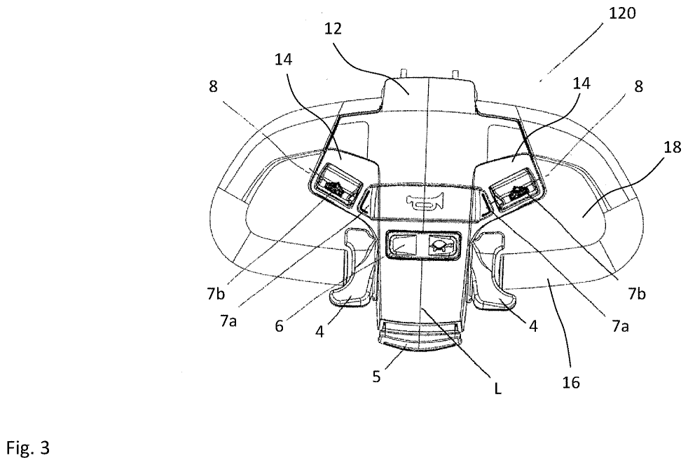

An example for the operating head 120 of the remote operating station 110 corresponding to an operating head of an industrial truck is shown in FIG. 3. The operating head 120 comprises a horn 12 that extends along a longitudinal axis L and that has support portions 14 extending from the longitudinal axis L on opposite sides of the horn 12, and said operating head also comprises handles that are connected to the horn 12 and that comprise gripping portions 16 arranged in each case opposite the support portions 14. The opposing support portions 14 and gripping portions 16 are in each case spaced apart from one another by means of a handle opening 18. The support portions 14 each comprise buttons 7a for sounding the horn as well as rockers 7b that can be titled about axes 8 for raising and lowering a load-carrying means. A stop button 5 and a locking rocker 6 for setting a permanent creep speed are also arranged on the horn 12. Driver gearshift handles 4 that can be rotated in each case about an axis that points from the horn 12 towards the respective gripping portions 16 are arranged on opposite ends of the horn 12 on the sides of a free end.

The operating elements 7a, 7b, 4, 5, 6 all correspond to the operating elements of an industrial truck, in particular the operating elements on the operating station of the industrial truck to be remotely controlled. The operating elements therefore allow for particularly simple and intuitive remote control.

### LIST OF REFERENCE SIGNS

4 Operating element
5 Stop button
6 Locking rockers
7a Button
7b Rockers
8 Axes
12 Horn
14 Support portion
16 Gripping portion
18 Handle opening
100 Driving simulator
110 Operating station/Remote operating station
115 Tiller
120 Operating head
125 Standing platform
130 Industrial truck
135 Switch
140 Cable connection
150 Radio connection
200 Industrial truck/AGV
220 Operating head
300 Control unit
310 Radio transmission path
400 Shelves
410 Pallets
411 Pallet
L Longitudinal axis

1. A device for remotely controlling at least one industrial truck, the device comprising:
a remote operating station comprising one or more operating elements that correspond to an operating station of the at least one industrial truck, wherein the one or more operating elements are configured to be actuated; and
a control unit configured to generate control signals in response to the actuation of the one or more operating elements, wherein the control unit is further configured to transmit the control signals to the at least one industrial truck via a radio transmission path.

2. The device according to claim 1, wherein the remote operating station further comprises a driving simulator.

3. The device according to claim 1, wherein the operating station of the at least one industrial truck is the remote operating station.

4. The device according to claim 3, wherein the at least one industrial truck is configured to be remotely controllable using an additional remote operating station.

5. The device according to claim 1, wherein the remote operating station comprises an operating head corresponding to the operating station of the at least one industrial truck, and wherein at least some of the operating elements are arranged on the operating head.

6. The device according to claim 5, wherein the remote operating station comprises a tiller corresponding to the tiller of the at least one industrial truck, wherein the tiller comprises a tiller shaft, wherein the operating head is positioned on a free end of the tiller shaft.

7. The device according to claim 6, wherein the operating head is a multi-functional steering wheel.

8. The device according to claim 1, wherein the control signals are transmitted in one of: (1) a continuous manner; or (2) in a clocked manner in order to secure the radio transmission.

9. The device according to claim 1, wherein the control unit is configured to secure the radio transmission path by means of at least one of a cyclic redundancy check (CRC) and a receiver-side flow control.

10. The device according to claim 1, wherein the control unit is configured to receive at least one of: (1) vehicle data; and (2) environmental data for the remote control from the at least one industrial truck, and wherein said data is used to generate the control signals and to display said data to the operator using a visualization device.

11. A system configured to remotely control at least one industrial truck, the system comprising:
device for remotely controlling the at least one industrial truck, the device comprising,
a remote operating station comprising one or more operating elements that are configured to be actuated, and
a control unit configured to generate control signals in response to the actuation of the one or more operating elements and further configured to transmit the control signals to the at least one industrial truck via a radio transmission path; and
an operating station of the at least one industrial truck that is configured to be controlled via the control signals.

12. The system according to claim 11, further comprising a driving simulator having the remote operating station.

13. The system according to claim 11, wherein the operating station of the at least one industrial truck comprises a remote operating station.

14. The system according to claim 13, the at least one industrial truck is configured to be remotely controllable using an additional remote operating station.

15. A method for remotely controlling at least one industrial truck comprising:
actuating one or more operating elements;
generating control signals in response to the actuation of the one or more operating elements; and
transmitting the control signals to the at least one industrial truck via a radio transmission path.

16. The method according to claim 15, wherein the at least one industrial truck is configured to receive the control signals and generate target values for control functions from the received control signals.
